(19) United States
(12) Patent Application Publication
(10) Pub. No.: US 2003/0126249 A1
(43) Pub. Date: Jul. 3, 2003

(54) Network monitoring device and computer system having the same

(75) Inventor: Ming-Chih Chang, Taipei (TW)

Correspondence Address: Richard P. Berg, Esq., c/o LADAS & PARRY, Suite 2100, 5670 Wilshire Boulevard, Los Angeles, CA, 90036-5679, US

(73) Assignee: ICP Electronics Inc.

(21) Appl. No.: 10/102,443

(22) Filed: Mar. 19, 2002

(30) Foreign Application Priority Data
Dec. 31, 2001 (TW) 90133410

(51) Int. Cl. G06F 15/173

(52) U.S. Cl. 709/223

(57) ABSTRACT

A network monitoring device and a computer system having the network monitoring device. The network monitoring device has a filtering device and a CPU, in which the filtering device is connected to a network interface of the computer system to selectively filter or cut the network data transmitted through the network interface, and the CPU is connected to the filtering device to control the filtering device to selectively transceive the network data transmitted through the network interface.

### BACKGROUND OF THE INVENTION

1. Field of the Invention

The present invention relates to a network monitoring device and a computer system with the network monitoring device, and particularly to a computer system with a network monitoring device embedded on the motherboard of the computer, in which only a sole network interface is applied.

2. Description of the Related Art

Presently, network systems are commonly involved in computer technology. A computer connected to a network system enables a user to operate the computer directly or remotely from another computer.

A network interface, such as a local area network (LAN) port, is provided in order to connect the computer to the network. The network interface may be generally provided on the motherboard of the computer, or on a network card detachably installed on the motherboard. Meanwhile, means of network monitoring may be provided in order to monitor the characteristics of the network, such as data transmitted via the network.

Conventionally, means of network monitoring may be achieved by either hardware or software. FIG. 1 shows an example of a conventional computer system with an external hardware-type network monitoring device. The conventional computer system has a central processing unit (CPU) 210 provided on the motherboard 200 to control the computer system, and the CPU 210 is connected to a network interface 240 via an intermediate (such as a PCI interface), so that the computer system is connected to the network 260 via the network interface 240. Further, an external network packet filtering device 230, e.g. a hardware firewall system, is provided between the network interface 240 and the network 260. When the computer system is online accessible via the network 260, the network packet filtering device 230 monitors and filters the data transmitted between the network 260 and the computer system. In this case, the network packet filtering device 230 serves as the network monitoring device.

Alternatively, a user may install a conventional network monitoring software package, e.g. WebSense, in the computer system to monitor the network characteristics instead of applying the external hardware-type network monitoring device.

There are significant drawbacks in either means of the conventional network monitoring, which is respectively described hereinafter.

If a user decides to install a conventional network monitoring software package in the computer system, the network monitoring software package must be compatible with the operating system. Even if the network monitoring software package is successfully installed, it must be stored in storage such as a hard disk and requires an executing action for regular operation. Therefore, it cannot monitor the network characteristics before the executing action and might be accidentally or intentionally suspended or interrupted in monitoring the network characteristics. Further, the network monitoring software package in operation consumes system resources, which may lead to reduced efficiency or performance.

On the other hand, if the conventional hardware-type network monitoring device is applied to the computer system, it is operated independently from the computer system, which solves the problem of system resource consumption. However, the network monitoring device is applied externally to the computer system, so that it is much easier for the user to remove the device or to connect to the network via another route in order to intentionally avoid monitoring.

### SUMMARY OF THE INVENTION

In view of this, an object of the present invention is to disclose a network monitoring device, and a computer system on whose motherboard the network monitoring device is independently embedded, so that the network monitoring process is independent from the computer system and is not allowed to be interrupted or avoided.

The present invention discloses a network monitoring device which has a filtering device and a CPU. The filtering device is connected to a network interface of the computer system to selectively filter or cut the network data transmitted via the network interface, and the CPU is connected to the filtering device in order to control the filtering device to selectively transceive the network data transmitted via the network interface.

Further, the present invention discloses a computer system having a first CPU, a network interface, and a network monitoring device. The network interface is connected to the first CPU to transmit network data. The network monitoring device has a filtering device connected to the network interface of the computer system to selectively filter or cut the network data transmitted via the network interface, and a second CPU connected to the filtering device to control the filtering device to selectively transceive the network data transmitted via the network interface.

Further, the network monitoring device of the present invention is preferably provided with storage to store relative data of the CPU on the network monitoring device. The storage can be random-access memory (RAM), flash memory or a hard disk, and the relative data stored in the storage preferably includes a log file of the network data, data referring to CPU temperature, voltage and fan information of the computer system. Further, the network interface can be a LAN port or a wireless network interface. Moreover, the network monitoring device of the computer system of the present invention may be remotely controlled by another computer via network.

### BRIEF DESCRIPTION OF THE DRAWINGS

The present invention can be more fully understood by reading the subsequent detailed description in conjunction with the examples and references made to the accompanying drawings, wherein:

FIG. 1 is a schematic diagram showing a computer system with a conventional external hardware-type network monitoring device; and

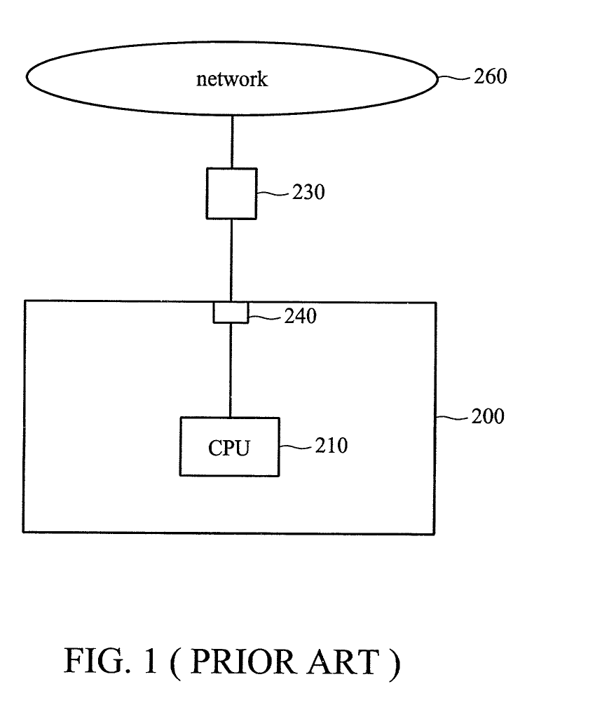

FIG. 2 is a schematic diagram showing an embodiment of the computer system having a network monitoring device of the present invention.

### DETAILED DESCRIPTION OF THE PREFERRED EMBODIMENT

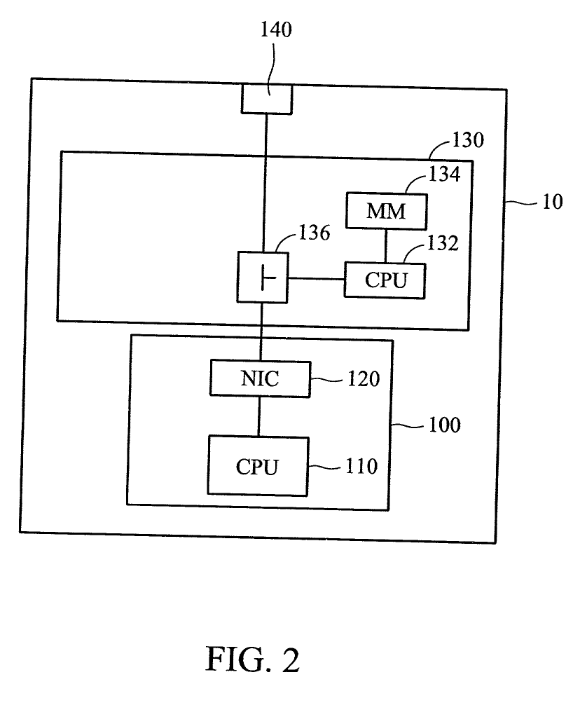

An embodiment of the computer system having the network monitoring device of the present invention is described hereinafter in detail with reference to FIG. 2.

The computer system of the present invention has a primary system 100, which includes a first CPU 110 and a network interface controller (NIC) 120, provided on the motherboard 10 of the computer, as shown in FIG. 2. The first CPU 110 serves as kernel of the primary system 100 and controls the computer system. The NIC 120 connects the first CPU 110 and a network interface 140 so that the first CPU 110 controls the network interface 140 via the NIC 120. The network interface 140 is preferably a LAN port, a wireless network interface such as an IR port, wireless protocol, or any other type of network interface.

Meanwhile, the computer system of the present invention is provided with an embedded network monitoring device 130. The network monitoring device 130 has a second CPU 132 and a filtering device 136. The filtering device 136 is connected to the network interface 140 so that the second CPU 132 controls the filtering device 136 to perform a filtering process. Thus, the network monitoring device 130 receives and filters incoming network data transmitted via the network interface 140 before the network data reaches the primary system 100; and the network monitoring device 130 receives and filters outgoing network data from primary system 100 before the network data is sent to the network interface 140. Further, the network monitoring device 130 has a priority to control the network transmission over the primary system 100 by performing the filtration; that is, the network monitoring device 130 is authorized to disconnect and connect the network interface 140 in case any network transmission toward/from the primary system 100 via the network interface 140 might cause security problem.

In the embodiment of the present invention, the network monitoring device 130 has storage 134, such as RAM (denoted as MM in FIG. 2), flash memory, a hard disk, or any other type of storage device. The storage 134 stores relative data of the second CPU 132, such as a log file of the network data, data referring to CPU temperature, voltage and fan information of the computer system, or any other system characteristic information.

Further, the network monitoring device 130 of the present invention may be remotely controlled by a remote computer via network. In this case, the remote computer directly controls the network monitoring device 130 without resource consumption of the primary system 100, and the user is not easily aware of the monitoring process. Thus, a supervisor may monitor network activities occurring in real time in the computer system remotely. If real-time monitoring is not necessary, the supervisor may check the data stored in the storage 134 afterwards.

It should be noted that the network monitoring device 130 is embedded on the motherboard 10 of the computer system, so that no external hardware device such as network interface is required for monitoring. Thus, since it is not easy for the user of the computer system to accidentally interrupt or intentionally remove the embedded device to avoid monitoring, reliability of the network monitoring device 130 is ensured.

Further, the second CPU 132 of the network monitoring device 130 is independent from the first CPU 110 of the primary system 100, so that the monitoring operation does not consume resources of the primary system 100 and need not be compatible with the OS of the computer system.

Further, the network monitoring device 130 serves as a subsystem of the computer system, so an independent power supply is preferably applied for uninterrupted network monitoring. In this case, the network monitoring device 130 continues monitoring even if the primary system 100 is shut down, halted, or in a standby mode, and the supervisor may check the data stored in the storage 134 regardless of status of the primary system 100.

Specifically, the primary system 100 is preferably accessible via the network monitoring device 130, so that the supervisor may remotely access the computer system in order to ensure further network security control. For example, the network monitoring device 130 provided with a power supply controller of the primary system or a BIOS controller enables the supervisor to remotely access and restore the computer system in case the computer system is intruded or disabled.

While the present invention has been described with reference to the preferred embodiments thereof, it is to be understood that the invention is not limited to the described embodiments or constructions. On the contrary, the invention is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A network monitoring device for a computer system, comprising:
a filtering device connected to a network interface of the computer system to selectively filter network data transmitted via the network interface; and
a CPU connected to the filtering device to control the filtering device to selectively transceive the network data transmitted via the network interface.

2. The network monitoring device according to claim 1, further comprising storage to store relative data of the CPU.

3. The network monitoring device according to claim 2, wherein the storage is random-access memory (RAM).

4. The network monitoring device according to claim 2, wherein the storage is flash memory.

5. The network monitoring device according to claim 2, wherein the storage is a hard disk.

6. The network monitoring device according to claim 2, wherein the relative data comprises a log file of the network data.

7. The network monitoring device according to claim 2, wherein the relative data comprises data referring to CPU temperature, voltage and fan information of the computer system.

8. The network monitoring device according to claim 1, wherein the network interface is a local area network (LAN) port.

9. The network monitoring device according to claim 1, wherein the network interface is a wireless network interface.

10. A computer system, comprising:
a first CPU;
a network interface connected to the first CPU to perform transmission of network data; and
a network monitoring device, comprising:
a filtering device connected to the network interface of the computer system to selectively filter the network data transmitted via the network interface; and
a second CPU connected to the filtering device to control the filtering device to selectively transceive the network data transmitted via the network interface.

11. The computer system according to claim 10, further comprising a network interface controller for connecting the first CPU and the network interface.

12. The computer system according to claim 10, wherein the network monitoring device further comprises storage to store relative data of the second CPU.

13. The computer system according to claim 12, wherein the storage is random-access memory (RAM).

14. The computer system according to claim 12, wherein the storage is flash memory.

15. The computer system according to claim 12, wherein the storage is a hard disk.

16. The computer system according to claim 12, wherein the relative data comprises a log file of the network data.

17. The computer system according to claim 12, wherein the relative data comprises data referring to CPU temperature, voltage and fan information of the computer system.

18. The computer system according to claim 10, wherein the network interface is a local area network (LAN) port.

19. The computer system according to claim 10, wherein the network interface is a wireless network interface.

20. The computer system according to claim 10, wherein the network monitoring device is remotely controlled by a remote computer via network.
